(19) United States
(12) Patent Application Publication
(10) Pub. No.: US 2026/0187740 A1
(43) Pub. Date: Jul. 2, 2026

(54) AI-ASSISTED SYSTEM AND METHOD FOR FACILITATING REAL ESTATE TRANSACTIONS

(71) Applicant: Agnt LLC, MIAMI, FL (US)

(72) Inventors: Greg Piechota, Miami, FL (US); Mike Piechota, Miami, FL (US); Nick Markham, Miami, FL (US); Alex De La Cruz, Miami, FL (US)

(21) Appl. No.: 19/433,234

(22) Filed: Dec. 26, 2025

Related U.S. Application Data
(60) Provisional application No. 63/739,012, filed on Dec. 26, 2024.

(51) Int. Cl. G06Q 50/16; G06Q 10/10

(52) U.S. Cl. CPC G06Q 50/16; G06Q 10/10; G06Q 2220/00

(57) ABSTRACT

A computer-implemented system facilitates real estate transactions over a communications network by automating property discovery, offer creation, compliance validation, and transaction tracking. The system provides a graphical user interface that receives structured search parameters and natural-language queries, applies a machine-learning ranking model to generate ranked property listings, and presents the listings in map-based and list-based visualizations. A document parsing module automatically parses state-specific residential purchase agreement templates to identify required contractual fields and jurisdiction-specific addenda. An offer generation module converts the parsed fields into an interactive workflow, automatically populates contractual terms using market and comparable transaction data, and generates a completed purchase agreement document. A compliance validation module analyzes the document against jurisdiction-specific legal requirements and enforces automated submission gating. Upon approval, the system electronically transmits the document, tracks transaction states in real time, and provides contextual explanations via a conversational artificial intelligence module.

### CROSS REFERENCE TO RELATED APPLICATIONS

This patent application claims priority to provisional patent application 63/739,012 file 12/26/2024 and title AI-Assisted System and Method for Facilitating Real Estate Transactions. The subject matter of provisional patent application 63/739,012 is hereby incorporated by reference in its entirety.

### TECHNICAL FIELD

The technical field relates generally to real estate transaction systems and methods, and more particularly to artificial intelligence (AI)-powered platforms designed to facilitate and streamline the real estate buying and selling processes.

### BACKGROUND

The process of purchasing and selling real estate properties, particularly residential homes, has long been recognized as complex and often overwhelming for prospective buyers and sellers. Traditionally, this process requires the involvement of multiple parties, including real estate agents, legal professionals, and financial institutions. Buyers and sellers typically rely heavily on real estate agents to guide them through each step, from searching for suitable properties to negotiating and finalizing offers. This dependency stems from the intricate nature of real estate transactions, which involve understanding legal contracts, market conditions, regulatory requirements, and financial implications.

Current methods of facilitating real estate transactions are characterized by several challenges. Communication between buyers, sellers, and agents can be inefficient, leading to delays and misunderstandings. Scheduling property showings often requires coordinating between multiple parties, which can be time-consuming and inconvenient. Additionally, the process of creating and submitting offers is complex, requiring careful attention to legal details and adherence to regional regulations. Mistakes or omissions in offer documents can result in unfavorable outcomes or legal complications for buyers.

Existing platforms and tools in the real estate industry primarily focus on listing properties and providing basic market information. While some offer limited online communication features, they generally do not provide comprehensive assistance throughout the entire buying process. These platforms may lack interactive guidance for offer creation, fail to ensure compliance with legal standards, and do not adequately educate buyers about the steps involved in a transaction. As a result, buyers may feel uninformed and dependent on agents for critical decision-making.

Furthermore, the traditional reliance on real estate agents can increase the overall cost of purchasing or selling a property due to agent commissions and fees. In some cases, buyers may feel that their interests are not fully aligned with those of their agents, leading to potential conflicts. The lack of transparency and control over the transaction process can contribute to buyer frustration and dissatisfaction.

Therefore, a need exists to overcome the problems with the prior art as discussed above, and particularly for a more efficient and economical method and systems that facilitates the buying and selling of real estate.

### SUMMARY

A computer-implemented system and method for facilitating real estate transactions is provided. This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

In one embodiment, a computer-implemented system for facilitating real estate transactions over a communications network is disclosed. The system comprises a network-connected computing platform including one or more processors and non-transitory memory storing executable instructions that, when executed, cause the system to perform operations comprising providing, via a graphical user interface rendered on a user device, a property discovery module including receiving structured search parameters and natural-language search prompts from a user, executing a machine-learning ranking model trained on historical transaction data and user interaction data to generate a ranked subset of property listings, and dynamically generating a dual-mode display comprising a map-based visualization and a list-based visualization of the ranked subset; executing a document parsing module configured to automatically parse a state-specific residential purchase agreement template to identify required contractual fields, field types, and jurisdiction-specific addenda; executing an offer generation module that converts the identified contractual fields into an interactive, machine-generated offer workflow comprising sequential prompts rendered via the graphical user interface, automatically populates at least a portion of the contractual fields based on market data, comparable transaction data, and a user-selected offer strategy, and generates a completed purchase agreement document in a standardized electronic format; executing a compliance validation module that automatically analyzes the completed purchase agreement document by cross-referencing jurisdiction-specific legal rules and transaction requirements stored in a legal rules data store and generates a compliance status output indicating whether the document satisfies applicable legal and regulatory constraints; executing an automated submission module that, responsive to user approval and a compliant status output, electronically transmits the completed purchase agreement document to a recipient computing system associated with a seller or listing agent and generates delivery confirmation data; executing a transaction state module that monitors post-submission transaction events and updates a transaction status dashboard in real time, including offer review, acceptance, rejection, or counteroffer events; and executing a conversational artificial intelligence module trained on real estate transaction documents and workflows that automatically generates contextual explanations of contractual terms and transaction states in response to user queries.

In another embodiment, the machine-learning ranking model is further trained using implicit behavioral signals comprising at least one of property view duration, search refinement frequency, saved listings, or prior offer activity associated with the user.

Additional aspects of the claimed subject matter will be set forth in part in the description which follows, and in part will be obvious from the description, or may be learned by practice of the claimed subject matter. The aspects of the claimed subject matter will be realized and attained by means of the elements and combinations particularly pointed out in the appended claims. It is to be understood that both the foregoing general description and the following detailed description are exemplary and explanatory only and are not restrictive of the disclosed subject matter, as claimed.

### BRIEF DESCRIPTION OF THE DRAWINGS

The accompanying drawings, which are incorporated in and constitute part of this specification, illustrate embodiments of the claimed subject matter and together with the description, serve to explain the principles of the claimed subject matter. The embodiments illustrated herein are presently preferred, it being understood, however, that the claimed subject matter is not limited to the precise arrangements and instrumentalities shown, wherein:

FIG. 1 is a block diagram illustrating the network architecture of a computer-implemented AI-assisted system for facilitating real estate transactions, according to an embodiment.

FIG. 2A is a block diagram showing the data flow of the computer-implemented AI-assisted process for facilitating real estate transactions, according to an embodiment.

FIG. 2B is a block diagram showing the different modules of the computer-implemented AI-assisted process for facilitating real estate transactions, according to an embodiment.

FIG. 3 is a flow chart depicting the general control flow of the process undertaken by the computer-implemented AI-assisted system for facilitating real estate transactions, according to an embodiment.

FIG. 4 is a block diagram depicting a system including an example computing device and other computing devices.

### DETAILED DESCRIPTION

The following detailed description refers to the accompanying drawings. Wherever possible, the same reference numbers are used in the drawings and the following description to refer to the same or similar elements. While embodiments of the claimed subject matter may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the claimed subject matter. Instead, the proper scope of the claimed subject matter is defined by the appended claims.

The claimed embodiments overcome the limitations inherent in traditional real estate transactions by introducing an AI-powered platform that facilitates the home buying process. The claimed embodiments integrate advanced artificial intelligence algorithms with an intuitive user interface to provide step-by-step assistance to users, thereby simplifying complex procedures and reducing reliance on real estate agents. The claimed embodiments enhance communication efficiency by enabling buyers to schedule property showings directly through the user interface. This feature eliminates the need for prolonged coordination between multiple parties, as the AI system accesses real-time availability data to arrange appointments that suit both buyers and sellers. By streamlining this process, the platform reduces delays and enhances the overall user experience.

To address the complexities associated with offer creation and submission, the claimed embodiments incorporate an offer generation module. This module guides users through each stage of crafting an offer by prompting for necessary information and explaining legal terms in accessible language. The AI system automatically populates standard contractual clauses and adjusts for regional legal requirements, ensuring that the offer is both complete and compliant. This reduces the likelihood of errors or omissions that could adversely affect the transaction. The backend processing unit of the claimed embodiments serves as a critical component in ensuring accuracy and regulatory compliance. It reviews the completed offer forms, cross-referencing data with relevant legal databases and property records. This automated verification process ensures that all documents adhere to current laws and regulations, mitigating the risk of legal complications for the buyer. By automating compliance checks, the platform enhances the reliability and integrity of the transaction process.

An educational component of the claimed embodiments is integrated into the platform to empower users with knowledge throughout their home buying journey. Contextual information is provided at each step, offering insights into market trends, property valuations, and the implications of various contractual terms. This feature simplifies the real estate process, enabling buyers to make informed decisions without solely relying on agent expertise.

By reducing dependence on traditional real estate agents, the claimed embodiments lower the overall costs associated with purchasing a property. The AI-powered platform minimizes intermediary fees and commissions, making real estate services more accessible to a broader audience. Additionally, the system fosters greater transparency and control for the buyer, enhancing trust and satisfaction in the transaction process.

The claimed embodiments further overcome deficiencies of the prior art by replacing fragmented, manual, and error-prone real estate transaction workflows with an integrated, computer-implemented system that automates end-to-end transaction processing. Conventional platforms primarily provide static property listings and basic communication tools, requiring users and agents to manually draft offers, interpret legal requirements, and coordinate compliance across multiple documents and parties. In contrast, the claimed embodiments employ automated document parsing of state-specific purchase agreement templates, machine-generated offer workflows, and rule-based compliance validation to ensure that legally operative transaction documents are generated, populated, and verified in a consistent and jurisdiction-appropriate manner. By embedding these functions directly into the computing platform, the system reduces drafting errors, eliminates redundant manual review, and enforces transaction constraints through executable system logic rather than human interpretation.

Additionally, the claimed embodiments address limitations of prior art systems that merely analyze or display information without effectuating concrete transaction outcomes. Existing solutions typically rely on human decision-making after presenting market data or recommendations, which introduces delays and inconsistencies in transaction execution. The claimed system integrates machine-learning-driven property discovery, automated offer strategy population, gated electronic submission, and real-time transaction state tracking into a closed-loop architecture in which system outputs directly control subsequent system behavior. As a result, the embodiments improve the functioning of computer-implemented transaction systems by coordinating distributed users, documents, and compliance requirements through automated processes, thereby enhancing efficiency, reliability, and transparency in real estate transactions beyond what is achievable using prior art approaches.

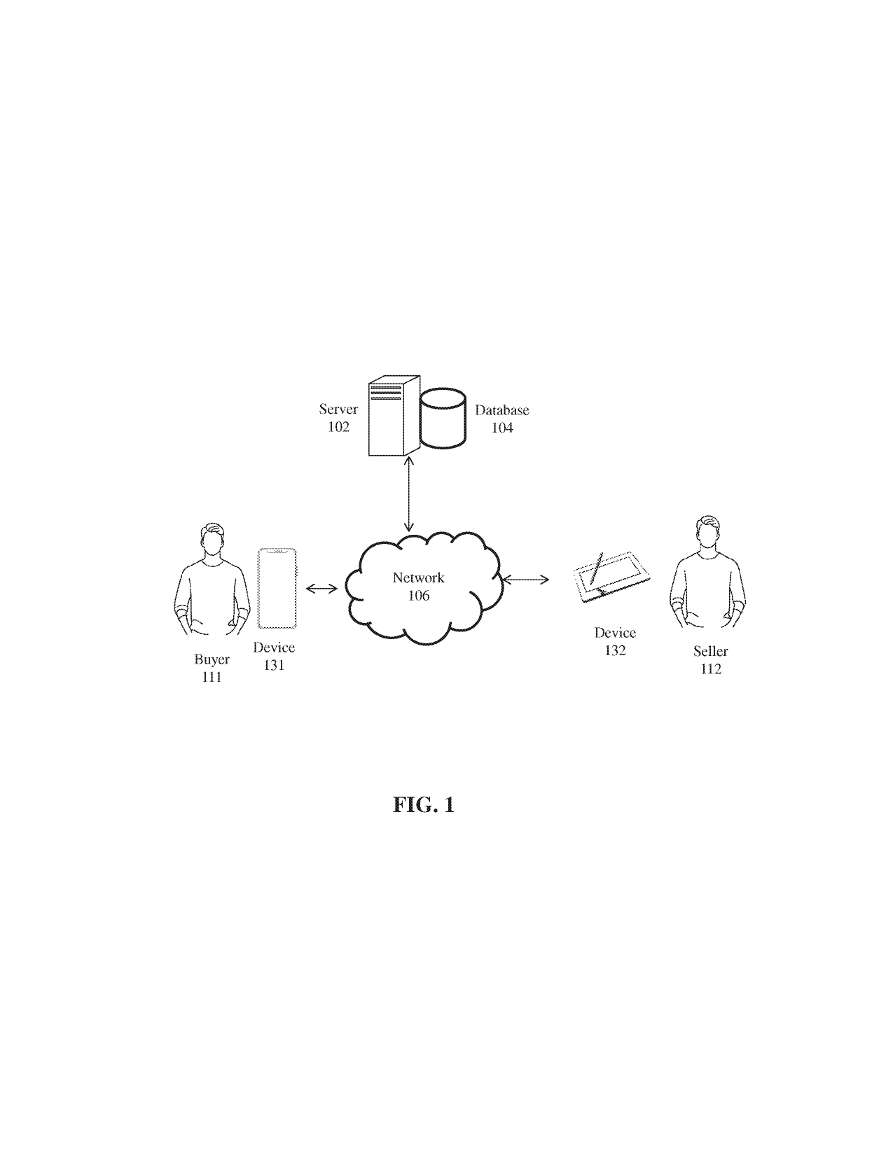

The accompanying drawings, which are incorporated in and constitute a part of this disclosure, illustrate various example embodiments. The claimed computer-implemented AI-assisted system 100 and method 300 for facilitating real estate transactions will now be described with respect to FIGS. 1 through 4.

Referring now to the drawing figures having numerical reference designators for the elements depicted, there is shown in FIG. 1 an illustration of a block diagram showing the network architecture of the computer-implemented AI-assisted system 100 and method for facilitating real estate transactions in accordance with one embodiment. A prominent element of FIG. 1 is the server 102 associated with repository or database 104 and further communicatively coupled with network 106, which can be a circuit switched network, such as the Public Service Telephone Network (PSTN), or a packet switched network, such as the Internet or the World Wide Web, the global telephone network, a cellular network, a mobile communications network, or any combination of the above. Server 102 is a central controller or operator for functionality of the disclosed embodiments, namely, facilitating real estate transactions.

FIG. 1 includes mobile computing devices 131, 132, which may be smart phones, mobile phones, tablet computers, handheld computers, laptops, or the like. In another embodiment, mobile computing devices 131 and 132 are workstations, desktop computers, servers, laptops, all-in-one computers, and the like. In another embodiment, mobile computing devices 131 and 132, are AR or VR systems that may include display screens, headsets, heads up displays, helmet mounted display screens, tracking devices, and the like. Mobile computing device 132 corresponds to a purchaser or buyer 112 of real estate, or someone assisting the buyer, such as a real estate agent. Mobile computing device 131 corresponds to a seller 111 of or real estate, or someone assisting the seller, such as a real estate agent. Devices 102, 131 and 132 may be communicatively coupled with network 106 in a wired or wireless fashion.

FIG. 1 further shows that server 102 includes a database or repository 104, which may be a relational database comprising a Structured Query Language (SQL) database stored in a SQL server. Devices 102, 131 and 132 may also each include their own database. The repository 104 serves data from a database, which is a repository for data used by server 102 and devices 131 and 132 during the course of operation of the disclosed embodiments. Database 104 may be distributed over one or more nodes or locations that are connected via network 106.

The database 104 may include a user record for each user 111 or 112. A user record may include contact/identifying information for the user (name, address, telephone number(s), email address, etc.), information pertaining to properties associated with the user, contact/identifying information for real estate agents of the user, electronic payment information for the user, information pertaining to previous real estate purchases made by the user, sales transaction data associated with the user, etc. A user record may also include a unique identifier for each user, the current location of each user (based on location-based services from the user’s mobile computer) and a description of desired properties of the user.

A user record may also include links to one or more property records. Property records include the property's legal description, such as lot and block numbers, which precisely define its location within a municipality. Property records also list ownership information, documenting the names of current and previous owners and the dates of any title transfers. Financial encumbrances like mortgages, liens, or easements are noted, indicating any claims or rights others may have on the property. Additionally, property records provide assessed values used for taxation purposes, reflecting the property's estimated market value. Information about zoning classifications and land use restrictions may also be included, outlining what can and cannot be done on the property. Building permits and records of any improvements or modifications to structures on the land are often part of the record as well.

FIG. 1 shows an embodiment wherein networked computing devices 131 and 132 interact with server 102 and repository 104 over the network 106. It should be noted that although FIG. 1 shows only the networked computers 131, 132 and 102, the system of the disclosed embodiments supports any number of networked computing devices connected via network 106. Further, server 102, and devices 131, 132 include program logic such as computer programs, mobile applications, executable files or computer instructions (including computer source code, scripting language code or interpreted language code that may be compiled to produce an executable file or that may be interpreted at run-time) that perform various functions of the disclosed embodiments.

Note that although server 102 is shown as a single and independent entity, in one embodiment, the functions of server 102 may be integrated with another entity, such as one of the devices 131 and 132. Further, server 102 and its functionality, according to a preferred embodiment, can be realized in a centralized fashion in one computer system or in a distributed fashion wherein different elements are spread across several interconnected computer systems.

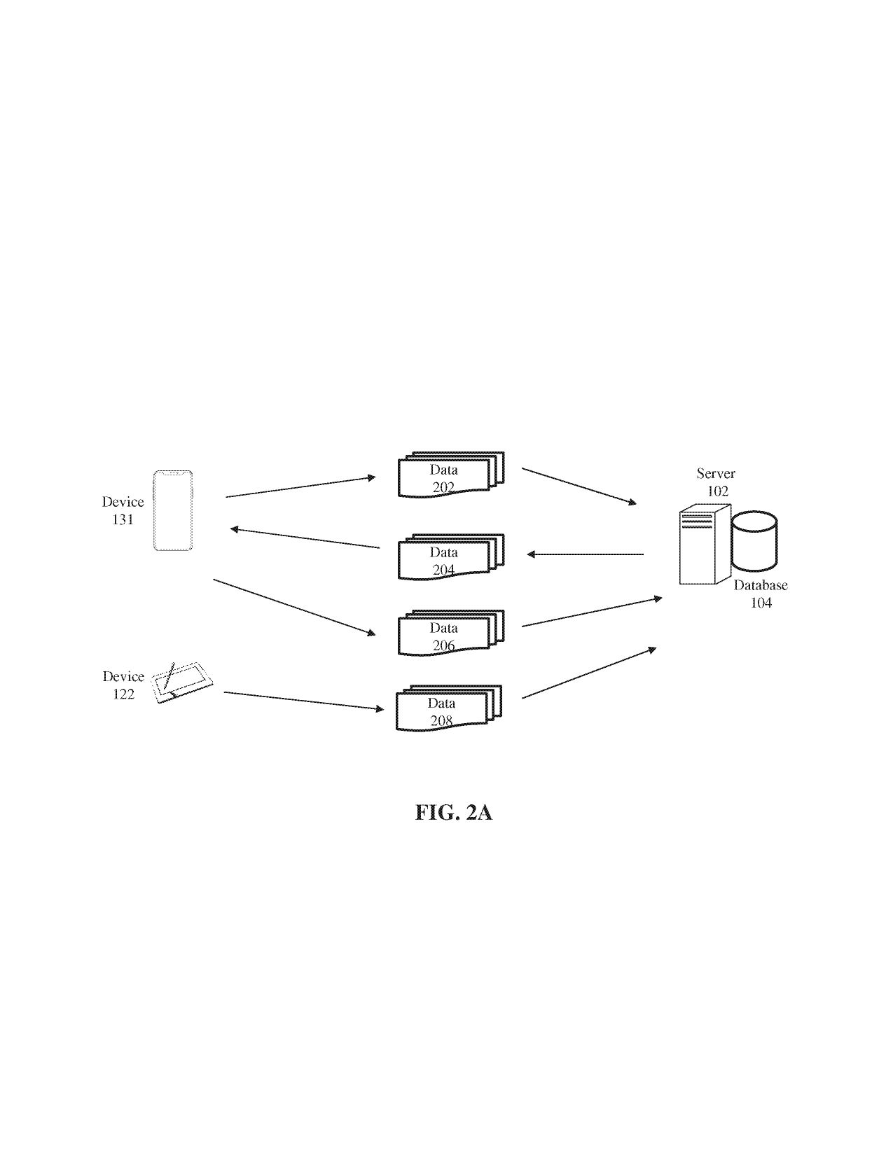

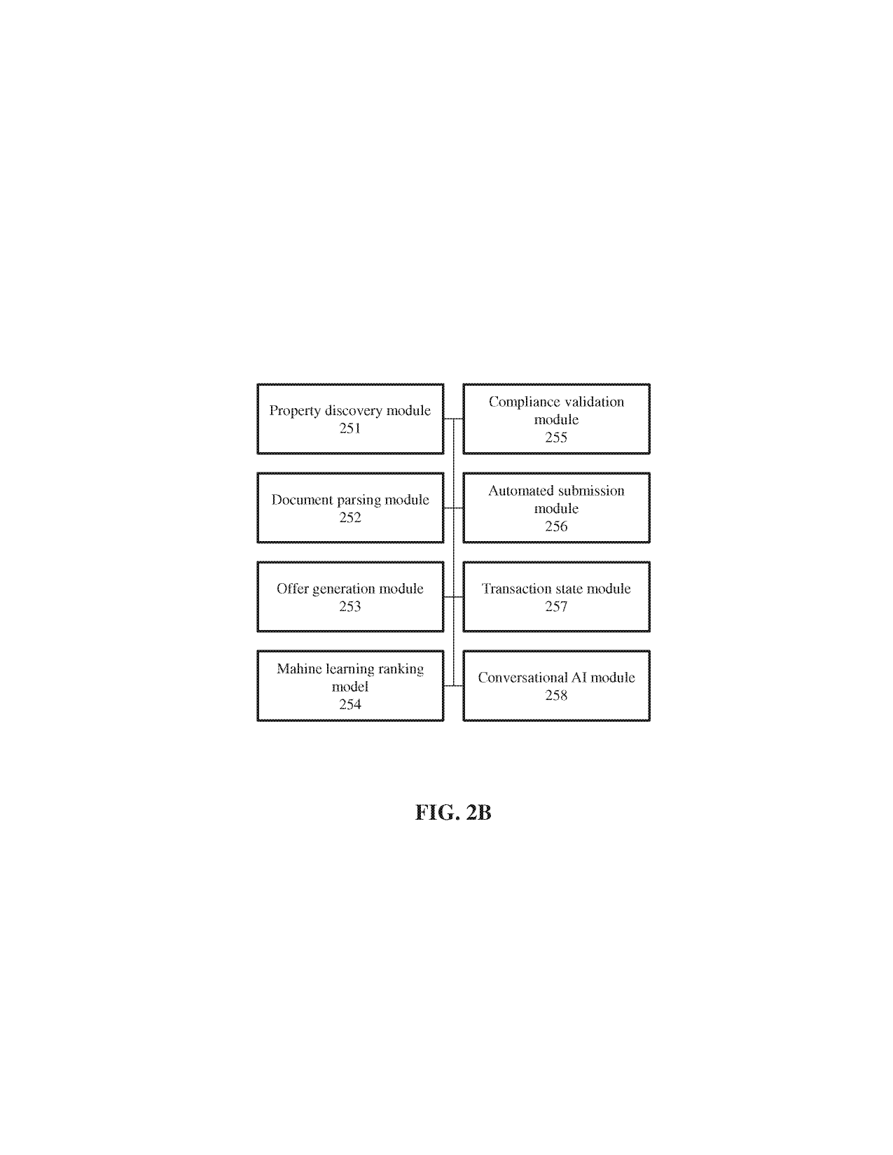

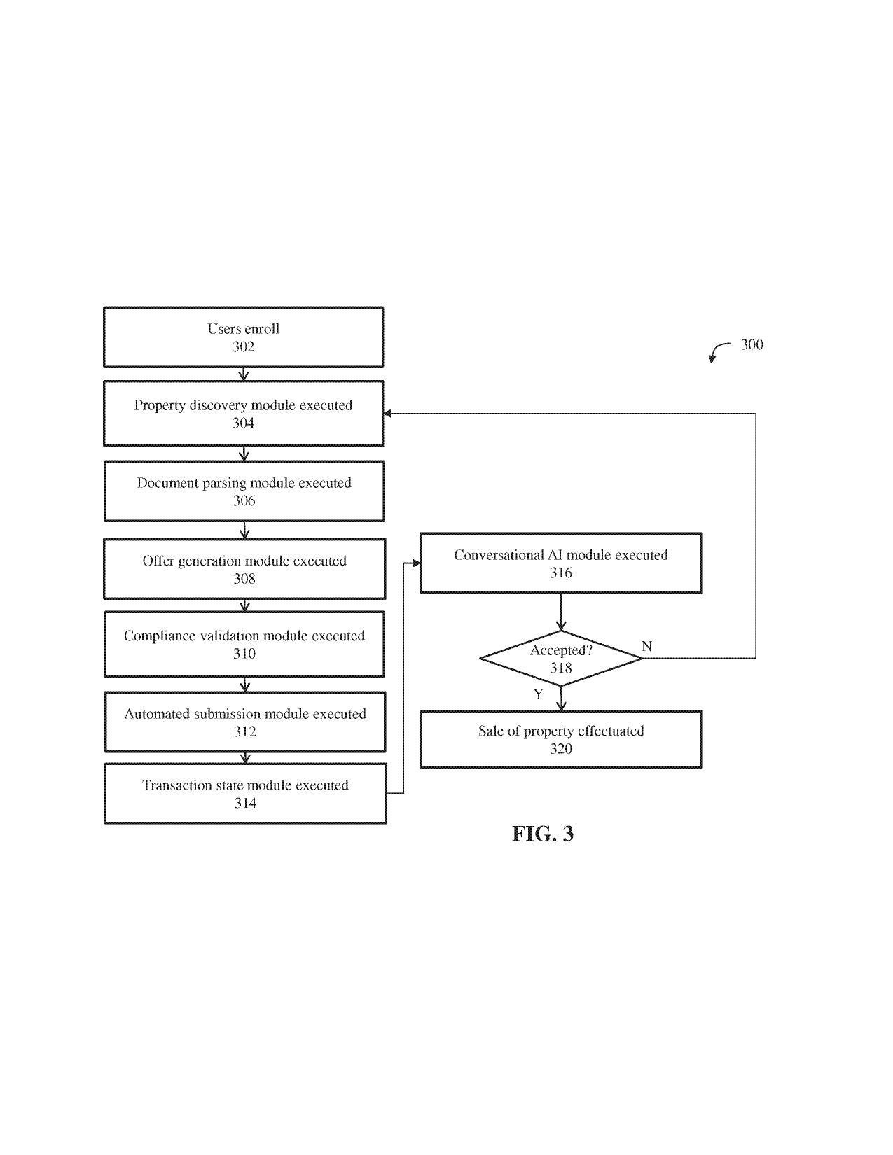

The process of AI-assisted facilitation of real estate transactions will now be described with reference to FIGS. 2A, 2B and 3 below. FIGS. 2A and 3 depict the data flow and control flow of the process for AI-assisted facilitation of real estate transactions, according to one embodiment. FIG. 2B depicts the different modules used in the process for AI-assisted facilitation of real estate transactions, according to one embodiment.

In one embodiment, the process begins at step 302 (FIG. 3) when a buyer user account and/or a seller user account is created through a client module executing on a user device 131 or 132 (FIG. 1). The user device 131, 132 communicates with a network-connected computing platform implemented by server 102 over network 106. Server 102 stores and retrieves user records, property records, transaction records, and rules data from a repository 104. The repository 104 may store (i) historical transaction data, (ii) user interaction data, (iii) jurisdiction-specific purchase agreement templates, and (iv) jurisdiction-specific legal rules used for automated compliance checks.

During step 302, the buyer provides structured search parameters (such as location, price range, property type, and minimum bedrooms) and may also provide natural-language prompts through a conversational input field presented in a graphical user interface. In one embodiment, the platform uses an NLP module and a conversational AI model to interpret the natural-language prompts, request clarifications, and normalize the prompts into structured intent signals usable by downstream modules. User inputs and the derived intent signals may be saved in the repository 104 as user interaction data for use in ranking, recommendations, and offer strategy selection.

At step 304 (FIG. 3), the property discovery module 251 (FIG. 2B) is executed by the network-connected computing platform. The property discovery module 251 obtains candidate listings responsive to the buyer’s structured parameters and the interpreted natural-language intent. The module 251 executes a machine-learning ranking model 254 trained on historical transaction data and user interaction data to produce a ranked subset of property listings. In one embodiment, the model 254 is further trained using implicit behavioral signals including property view duration, search refinement frequency, saved listings, and prior offer activity. The property discovery module 251 then renders a dual-mode display on the user device, including a map-based visualization and a list-based visualization of the ranked subset, and flags suggested listings near the top of the list view based on the ranking output.

In one embodiment, when a listing is selected from the dual-mode display, the graphical user interface transitions to a property detail page that presents core property data (including price, size, features, and images) and one or more supplementary data layers. The supplementary data layers may include transaction history, ownership records, neighborhood scoring data, school scoring data, demographic data, and market statistics such as median prices, days-on-market, inventory levels, and appreciation trends. The property detail page further provides selectable next actions including (i) “Write an Offer,” (ii) “Schedule a Showing,” and (iii) “Ask AI,” where “Ask AI” launches the conversational artificial intelligence module to answer user questions about the property data and the transaction workflow.

In one embodiment, selection of “Schedule a Showing” triggers a scheduling workflow executed by the platform that coordinates availability between the buyer device 132 and a seller-side device 131 and/or an agent device. The platform may access calendar availability data and apply automated scheduling logic to identify available time windows and generate proposed showing appointments for user confirmation. Upon confirmation, the platform stores showing appointment data in the repository 104 and transmits appointment notifications over network 106 to the relevant devices.

In one embodiment, selection of “Write an Offer” initiates step 306 (FIG. 3) and causes the document parsing module 252 (FIG. 2B) to identify a state-specific residential purchase agreement template associated with a jurisdiction of the subject property. The document parsing module 252 automatically parses the template to identify required contractual fields, field types (including text fields, checkboxes, and dropdown fields), and jurisdiction-specific addenda. In one embodiment, addenda are automatically selected and incorporated based on template metadata, property attributes, and transaction attributes, including HOA-related addenda, condominium addenda, financing addenda, and other state or local addenda.

At step 308 (FIG. 3), the offer generation module 253 (FIG. 2B) converts the identified contractual fields into an interactive, machine-generated offer workflow presented through sequential prompts rendered on the graphical user interface of the buyer device 132. In one embodiment, the sequential prompts are generated by transforming parsed contractual fields into natural-language questions and ordering the questions based on dependencies between contract terms. The workflow may present embedded educational content, FAQs, and short tutorials associated with each prompt to help a buyer understand contract terms and typical timelines.

In one embodiment, the offer workflow supports two offer-completion modes. In a first mode, the buyer manually enters and adjusts contract terms through the sequential prompts, and the platform records the structured inputs as field values associated with the template. In a second mode, the platform provides AI offer generation based on a user-selected offer strategy, where the user-selected offer strategy includes at least Conservative, Moderate, or Aggressive strategies. When the second mode is selected, the platform automatically populates at least a portion of the contractual fields using (i) market data, (ii) comparable transaction data, and (iii) strategy rules associated with the selected offer strategy.

In one embodiment, the strategy rules include defaults and ranges for key transaction terms including purchase price, initial deposit timing, additional deposit timing, loan approval period, appraisal contingency, inspection period, right-to-cancel timing, time for acceptance, closing date, delay extensions, possession timing, rent-back options, assignment terms, title objection periods, and survey objection periods. The platform may apply these strategy rules by calculating term values based on a list price, comparable sales, and market benchmarks. The platform then generates an editable summary of the auto-populated terms for user review and allows the buyer to modify one or more terms before document generation.

In one embodiment, the platform performs market intelligence and offer validation before finalizing the completed purchase agreement document. The platform generates a comparable analysis by applying filtering criteria to transaction datasets, including distance filters (for example, within a quarter mile to one mile), bedroom and bathroom similarity ranges, square footage similarity ranges, lot size similarity ranges, year-built similarity ranges, and sale-date recency filters. The platform may also compute normalized price-per-square-foot metrics to compare candidate comps.

In one embodiment, the platform provides a “Grade My Offer” function that scores the buyer’s offer and generates an explanation for the score. The score may be computed based on competitiveness signals derived from market data, including days-on-market, inventory, growth rate, and list-to-sold price ratios, and may further incorporate term competitiveness by comparing offer contingencies and time periods against jurisdiction-appropriate benchmarks. The score may be output as a letter grade or confidence score together with a textual explanation rendered on the user device.

In one embodiment, after the buyer completes the offer workflow, the platform generates a completed purchase agreement document in a standardized electronic format. The platform may use natural language generation (NLG) to generate human-readable contract language from structured field values and may merge the field values into the underlying state-specific purchase agreement template to produce an original-format PDF suitable for review and signature. The platform presents the completed purchase agreement document to the buyer through the graphical user interface for review and confirmation.

In one embodiment, prior to submission, the compliance validation module 255 (FIG. 2B) automatically analyzes the completed purchase agreement document in step 310 by cross-referencing jurisdiction-specific legal rules and transaction requirements stored in a legal rules data store maintained in repository 104. The compliance validation module 255 generates a compliance status output indicating whether the document satisfies applicable legal and regulatory constraints, and may identify missing fields, inconsistent selections, or disallowed combinations of terms based on the rules data store.

In one embodiment, the compliance validation module 255 enforces automated compliance gating. If the compliance status output indicates a non-compliant condition, the platform blocks submission and returns the user interface to one or more relevant prompts, together with machine-generated explanations of the non-compliance condition and corrective actions. If the compliance status output indicates a compliant condition, the platform enables the submission workflow and records the compliance outcome in repository 104.

In one embodiment, at step 312 (FIG. 3), responsive to user approval and a compliant status output, the automated submission module 256 (FIG. 2B) electronically transmits the completed purchase agreement document over network 106 to a recipient computing system associated with a seller or a listing agent. The automated submission module 256 generates delivery confirmation data including a timestamped receipt indicator and a recipient acknowledgment indicator, and stores the delivery confirmation data in repository 104 for retrieval by the transaction state module 257. In one embodiment, delivery confirmation data is cryptographically verifiable.

In one embodiment, following submission, the transaction state module 257 (FIG. 2B) monitors post-submission transaction events in step 314 and updates a transaction status dashboard in real time on the buyer device 132. The dashboard may display status states including offer delivered, offer viewed, offer accepted, offer rejected, and counteroffer received. The transaction state module 257 may synchronize transaction events received from multiple distributed computing systems associated with buyers, sellers, and agents, and may maintain a centralized communication thread for transaction messages associated with the offer.

In one embodiment, the conversational artificial intelligence module 258 (FIG. 2B), executed in step 316, provides contextual explanations of contractual terms and transaction states in response to user queries entered through the graphical user interface. The module 258 is trained on real estate transaction documents and workflows and generates explanations that are context-specific to the selected jurisdiction and the current stage of the transaction. In one embodiment, the module 258 retrieves definitions, references, and clause interpretations from a structured knowledge graph to generate responses that link concepts, terms, and workflow steps to the specific clauses of the completed purchase agreement document being reviewed.

In one embodiment, the platform uses OCR to extract data from uploaded documents used for user verification or offer preparation, including identity documents and financial documents. Extracted data may be mapped to user record fields and offer workflow fields stored in repository 104 and may reduce manual entry errors during the offer workflow.

In one embodiment, the process then proceeds to step 318 (FIG. 3), where acceptance, rejection, or a counteroffer event is captured by the transaction state module 257. If accepted, the platform updates the transaction status dashboard to indicate acceptance and generates task prompts and timeline outputs related to closing, including closing date, contingency deadlines, and deposit timing derived from the completed purchase agreement document. Subsequently, the property is sold in step 320. If rejected, the platform updates the dashboard to indicate rejection and allows the buyer to return to step 304 to search additional properties or revise offer strategy parameters for a subsequent offer. The flowchart 300 illustrates one example sequence, and additional steps such as scheduling, offer grading, or educational prompts may occur before, after, or concurrently with the illustrated steps.

When evaluated as a whole, the claims recite a practical application by using the claimed concepts to automatically control and transform computer-implemented transaction processing workflows, rather than merely producing information for human consideration. Specifically, the claims recite: automated parsing of jurisdiction-specific legal documents to identify required contractual fields; machine-generated interactive workflows that convert parsed legal requirements into executable system prompts; automated population of legally operative contract terms based on real-time market data and user-selected strategies; rule-based and machine-learning-driven compliance validation that gates further system actions; automatic electronic transmission of compliant offers and system-level transaction state tracking; and real-time system behavior changes (submission, blocking, updating dashboards) driven directly by AI outputs.

Here, the claimed system does not merely analyze, rank, score, or recommend. Instead, AI outputs are used to drive system-level actions that alter document generation, validation, transmission, and transaction state, thereby confining any abstract concept to a specific technological implementation.

The claimed embodiments further improve computer implemented transaction processing technology. The claimed embodiments also recite an improvement to computer functionality or to another technical field. The claimed embodiments improve computer technology by: replacing error-prone manual legal document drafting with automated document parsing and generation pipelines; enforcing jurisdiction-specific legal constraints through machine-executable compliance rules, rather than human interpretation; reducing system complexity and processing errors by automatically coordinating multiple transaction subsystems (search, offer generation, validation, submission, and tracking); and enabling closed-loop transaction control, where system outputs deterministically trigger subsequent system behavior.

Said improvements are implemented in software - particularly improvements to how systems operate, process data, and preserve correctness across complex workflows – which constitute non-abstract technological improvements to existing technology.

The claimed embodiments further recite technical solutions to technical problems arising specifically in computerized transaction systems, including heterogeneous document formats, jurisdiction-specific legal rule enforcement, automated compliance gating, and real-time system state coordination across distributed devices. The claimed embodiments further solves a computer-centric problem using computer-centric means, as is the case here. Hence the claimed embodiments recite a practical application that improves computer-implemented transaction processing systems.

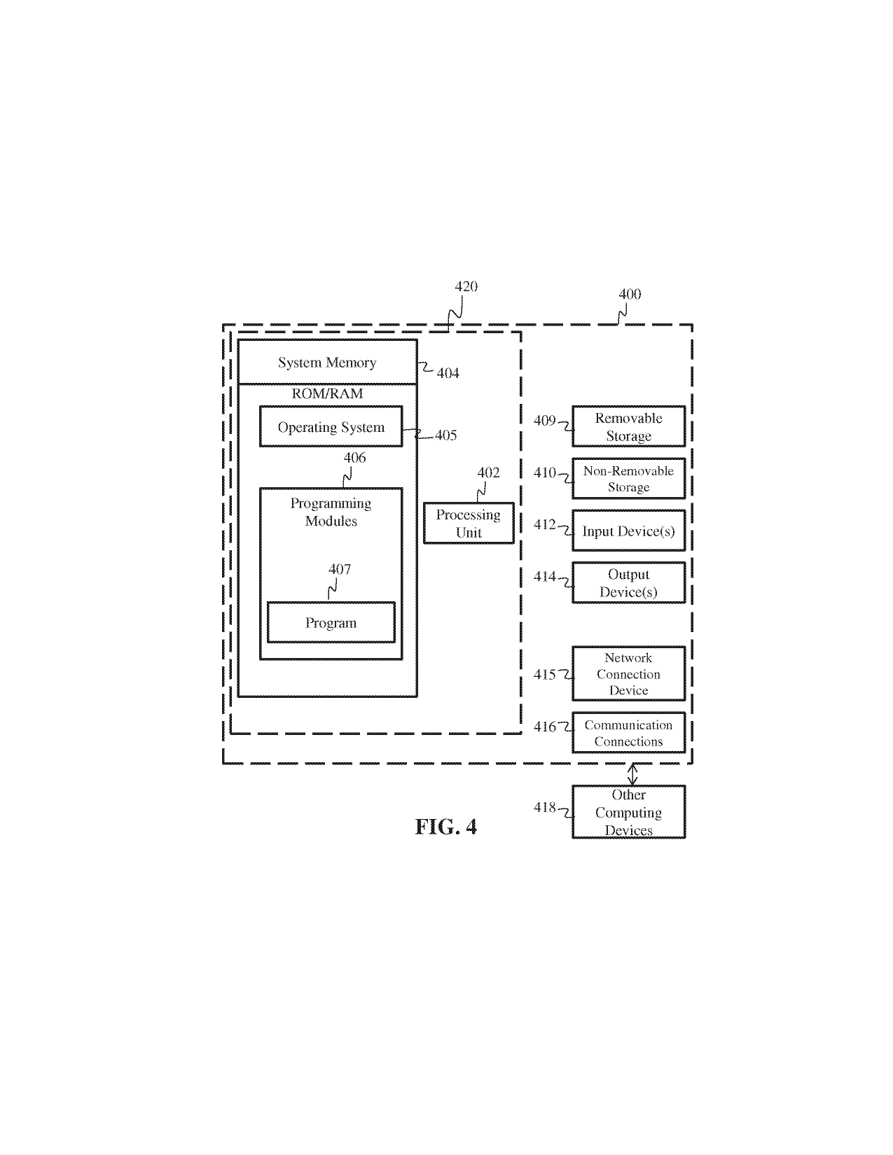

FIG. 4 is a block diagram of a system including an example computing device 400 and other computing devices. Consistent with the embodiments described herein, the aforementioned actions performed by server 102 and devices 131, 132 may be implemented in a computing device, such as the computing device 400 of FIG. 4. Any suitable combination of hardware, software, or firmware may be used to implement the computing device 400. The aforementioned system, device, and processors are examples and other systems, devices, and processors may comprise the aforementioned computing device. Furthermore, computing device 400 may comprise an operating environment for system 100 and process 300, as described above. Process 300 may operate in other environments and are not limited to computing device 400.

With reference to FIG. 4, a system consistent with an embodiment may include a plurality of computing devices, such as computing device 400. In a basic configuration, computing device 400 may include at least one processing unit 402 and a system memory 404. Depending on the configuration and type of computing device, system memory 404 may comprise, but is not limited to, volatile (e.g., random-access memory (RAM)), non-volatile (e.g., read-only memory (ROM)), flash memory, or any combination or memory. System memory 404 may include operating system 405, and one or more programming modules 406. Operating system 405, for example, may be suitable for controlling computing device 400's operation. In one embodiment, programming modules 406 may include, for example, a program module 407 for executing the actions of server 102 and devices 131, 132. In another embodiment, programming modules 406 may also include those modules and units shown in FIG. 2B. Furthermore, embodiments may be practiced in conjunction with a graphics library, other operating systems, or any other application program and is not limited to any particular application or system. This basic configuration is illustrated in FIG. 4 by those components within a dashed line 420.

Computing device 400 may have additional features or functionality. For example, computing device 400 may also include additional data storage devices (removable and/or non-removable) such as, for example, magnetic disks, optical disks, or tape. Such additional storage is illustrated in FIG. 4 by a removable storage 409 and a non-removable storage 410. Computer storage media may include volatile and nonvolatile, removable, and non-removable media implemented in any method or technology for storage of information, such as computer readable instructions, data structures, program modules, or other data. System memory 404, removable storage 409, and non-removable storage 410 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 400. Any such computer storage media may be part of device 400. Computing device 400 may also have input device(s) 412 such as a keyboard, a mouse, a pen, a sound input device, a camera, a touch input device, etc. Output device(s) 414 such as a display, speakers, a printer, etc. may also be included. Computing device 400 may also include a vibration device capable of initiating a vibration in the device on command, such as a mechanical vibrator or a vibrating alert motor. The aforementioned devices are only examples, and other devices may be added or substituted.

Computing device 400 may also contain a network connection device 415 that may allow device 400 to communicate with other computing devices 418, such as over a network in a distributed computing environment, for example, an intranet or the Internet. Device 415 may be a wired or wireless network interface controller, a network interface card, a network interface device, a network adapter, or a LAN adapter. Device 415 allows for a communication connection 416 for communicating with other computing devices 418. Communication connection 416 is one example of communication media. Communication media may typically be embodied by computer readable instructions, data structures, program modules, or other data in a modulated data signal, such as a carrier wave or other transport mechanism, and includes any information delivery media. The term "modulated data signal" may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both computer storage media and communication media.

As stated above, a number of program modules and data files may be stored in system memory 404, including operating system 405. While executing on processing unit 402, programming modules 406 (e.g., program module 407) may perform processes including, for example, one or more of the stages of process 300 as described above. The aforementioned processes are examples, and processing unit 402 may perform other processes. Other programming modules that may be used in accordance with embodiments herein may include electronic mail and contacts applications, word processing applications, spreadsheet applications, database applications, slide presentation applications, drawing or computer-aided application programs, etc.

Generally, consistent with embodiments herein, program modules may include routines, programs, components, data structures, and other types of structures that may perform particular tasks or that may implement particular abstract data types. Moreover, embodiments herein may be practiced with other computer system configurations, including hand-held devices, multiprocessor systems, microprocessor-based or programmable consumer electronics, minicomputers, mainframe computers, and the like. Embodiments herein may also be practiced in distributed computing environments where tasks are performed by remote processing devices that are linked through a communications network. In a distributed computing environment, program modules may be located in both local and remote memory storage devices.

Furthermore, embodiments herein may be practiced in an electrical circuit comprising discrete electronic elements, packaged or integrated electronic chips containing logic gates, a circuit utilizing a microprocessor, or on a single chip (such as a System on Chip) containing electronic elements or microprocessors. Embodiments herein may also be practiced using other technologies capable of performing logical operations such as, for example, AND, OR, and NOT, including but not limited to mechanical, optical, fluidic, and quantum technologies. In addition, embodiments herein may be practiced within a general-purpose computer or in any other circuits or systems.

Embodiments herein, for example, are described above with reference to block diagrams and/or operational illustrations of methods, systems, and computer program products according to said embodiments. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments have been described, other embodiments may exist. Furthermore, although embodiments herein have been described as being associated with data stored in memory and other storage mediums, data can also be stored on or read from other types of computer-readable media, such as secondary storage devices, like hard disks, floppy disks, or a CD-ROM, or other forms of RAM or ROM. Further, the disclosed methods' stages may be modified in any manner, including by reordering stages and/or inserting or deleting stages, without departing from the claimed subject matter.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer-implemented system for facilitating real estate transactions over a communications network, the system comprising a network-connected computing platform including one or more processors and non-transitory memory storing executable instructions that, when executed, cause the system to perform operations comprising:
a) providing, via a graphical user interface rendered on a user device, a property discovery module including
(i) receiving structured search parameters and natural-language search prompts from a user,
(ii) executing a machine-learning ranking model trained on historical transaction data and user interaction data to generate a ranked subset of property listings, and
(iii) dynamically generating a dual-mode display comprising a map-based visualization and a list-based visualization of the ranked subset;
b) executing a document parsing module configured to automatically parse a state-specific residential purchase agreement template to identify required contractual fields, field types, and jurisdiction-specific addenda;
c) executing an offer generation module that
(i) converts the identified contractual fields into an interactive, machine-generated offer workflow comprising sequential prompts rendered via the graphical user interface,
(ii) automatically populates at least a portion of the contractual fields based on market data, comparable transaction data, and a user-selected offer strategy, and
(iii) generates a completed purchase agreement document in a standardized electronic format;
d) executing a compliance validation module that automatically analyzes the completed purchase agreement document by cross-referencing jurisdiction-specific legal rules and transaction requirements stored in a legal rules data store, and generates a compliance status output indicating whether the document satisfies applicable legal and regulatory constraints;
e) executing an automated submission module that, responsive to user approval and a compliant status output, electronically transmits the completed purchase agreement document to a recipient computing system associated with a seller or listing agent, and generates delivery confirmation data;
f) executing a transaction state module that monitors post-submission transaction events and updates a transaction status dashboard in real time, including offer review, acceptance, rejection, or counteroffer events; and
g) executing a conversational artificial intelligence module trained on real estate transaction documents and workflows that automatically generates contextual explanations of contractual terms and transaction states in response to user queries.

2. The computer-implemented system of claim 1, wherein the machine-learning ranking model is further trained using implicit behavioral signals comprising at least one of property view duration, search refinement frequency, saved listings, or prior offer activity associated with the user.

3. The computer-implemented system of claim 1, wherein the document parsing module automatically identifies and incorporates jurisdiction-specific addenda by matching metadata of the residential purchase agreement template to a geographic location of a subject property.

4. The computer-implemented system of claim 1, wherein the offer generation module generates the interactive offer workflow by transforming parsed contractual fields into natural-language questions presented sequentially based on detected dependencies between contractual terms.

5. The computer-implemented system of claim 1, wherein the user-selected offer strategy comprises a selectable aggressiveness profile that automatically adjusts at least one of purchase price, deposit timing, contingency duration, or acceptance deadline based on market benchmark data.

6. The computer-implemented system of claim 1, wherein the compliance validation module prevents electronic transmission of the completed purchase agreement document when the compliance status output indicates a non-compliant condition, thereby enforcing automated compliance gating prior to submission.

7. The computer-implemented system of claim 1, wherein the automated submission module generates and stores cryptographically verifiable delivery confirmation data indicating successful transmission, recipient acknowledgment, and timestamped receipt of the completed purchase agreement document.

8. The computer-implemented system of claim 1, wherein the transaction state module updates the transaction status dashboard by automatically synchronizing transaction events received from multiple distributed computing systems associated with buyers, sellers, and agents.

9. The computer-implemented system of claim 1, wherein the conversational artificial intelligence module generates contextual explanations by dynamically retrieving and linking definitions, statutory references, and contract clause interpretations from a structured knowledge graph.

10. The computer-implemented system of claim 1, wherein execution of the document parsing module, offer generation module, compliance validation module, and automated submission module collectively replaces manual drafting and review of residential purchase agreements by enforcing end-to-end automated document generation and validation within the computing platform.

11. A non-transitory computer-readable medium storing executable instructions that, when executed by one or more processors of a network-connected computing platform, cause the computing platform to perform operations for facilitating real estate transactions over a communications network, the operations comprising:
a) providing, via a graphical user interface rendered on a user device, a property discovery module including
(i) receiving structured search parameters and natural-language search prompts from a user,
(ii) executing a machine-learning ranking model trained on historical transaction data and user interaction data to generate a ranked subset of property listings, and
(iii) dynamically generating a dual-mode display comprising a map-based visualization and a list-based visualization of the ranked subset;
b) executing a document parsing module configured to automatically parse a state-specific residential purchase agreement template to identify required contractual fields, field types, and jurisdiction-specific addenda;
c) executing an offer generation module that
(i) converts the identified contractual fields into an interactive, machine-generated offer workflow comprising sequential prompts rendered via the graphical user interface,
(ii) automatically populates at least a portion of the contractual fields based on market data, comparable transaction data, and a user-selected offer strategy, and
(iii) generates a completed purchase agreement document in a standardized electronic format;
d) executing a compliance validation module that automatically analyzes the completed purchase agreement document by cross-referencing jurisdiction-specific legal rules and transaction requirements stored in a legal rules data store, and generates a compliance status output indicating whether the document satisfies applicable legal and regulatory constraints;
e) executing an automated submission module that, responsive to user approval and a compliant status output, electronically transmits the completed purchase agreement document to a recipient computing system associated with a seller or listing agent, and generates delivery confirmation data;
f) executing a transaction state module that monitors post-submission transaction events and updates a transaction status dashboard in real time, including offer review, acceptance, rejection, or counteroffer events; and
g) executing a conversational artificial intelligence module trained on real estate transaction documents and workflows that automatically generates contextual explanations of contractual terms and transaction states in response to user queries.

12. The non-transitory computer-readable medium of claim 11, wherein the machine-learning ranking model is further trained using implicit behavioral signals comprising at least one of property view duration, search refinement frequency, saved listings, or prior offer activity associated with the user.

13. The non-transitory computer-readable medium of claim 11, wherein the document parsing module automatically identifies and incorporates jurisdiction-specific addenda by matching metadata of the residential purchase agreement template to a geographic location of a subject property.

14. The non-transitory computer-readable medium of claim 11, wherein the offer generation module generates the interactive offer workflow by transforming parsed contractual fields into natural-language questions presented sequentially based on detected dependencies between contractual terms.

15. The non-transitory computer-readable medium of claim 11, wherein the user-selected offer strategy comprises a selectable aggressiveness profile that automatically adjusts at least one of purchase price, deposit timing, contingency duration, or acceptance deadline based on market benchmark data.

16. The non-transitory computer-readable medium of claim 11, wherein the compliance validation module prevents electronic transmission of the completed purchase agreement document when the compliance status output indicates a non-compliant condition, thereby enforcing automated compliance gating prior to submission.

17. The non-transitory computer-readable medium of claim 11, wherein the automated submission module generates and stores cryptographically verifiable delivery confirmation data indicating successful transmission, recipient acknowledgment, and timestamped receipt of the completed purchase agreement document.

18. The non-transitory computer-readable medium of claim 11, wherein the transaction state module updates the transaction status dashboard by automatically synchronizing transaction events received from multiple distributed computing systems associated with buyers, sellers, and agents.

19. The non-transitory computer-readable medium of claim 11, wherein the conversational artificial intelligence module generates contextual explanations by dynamically retrieving and linking definitions, statutory references, and contract clause interpretations from a structured knowledge graph.

20. The non-transitory computer-readable medium of claim 11, wherein execution of the document parsing module, offer generation module, compliance validation module, and automated submission module collectively replaces manual drafting and review of residential purchase agreements by enforcing end-to-end automated document generation and validation within the computing platform.
